(19) United States
(12) Patent Application Publication
(10) Pub. No.: US 2025/0238309 A1
(43) Pub. Date: Jul. 24, 2025

(54) MANAGEMENT OF INCIDENT REMEDIATIONS ACROSS DATA PROCESSING SYSTEMS

(71) Applicant: Dell Products L.P., Round Rock, TX (US)

(72) Inventors: RAVEENDRA BABU MADALA, Agiripalli (IN); SANTOSH GORE, Bangalore (IN); SAKSHI GARG, Faridabad (IN)

(21) Appl. No.: 18/417,398

(22) Filed: Jan. 19, 2024

(51) Int. Cl. G06F 11/07; G06Q 10/0631

(52) U.S. Cl. CPC G06F 11/0793; G06F 11/0751; G06F 11/0766; G06Q 10/06311

(57) ABSTRACT

Methods and systems for managing data processing systems are disclosed. The data processing systems may be managed by monitoring remediation of incidents. The remediation of the incidents may be monitored by assigning personnel. Notifications of the assigning of personnel and progress of the remediation may be made to at least two other data processing systems. The at least two other data processing systems may update the status of a data processing with the incident as the progress of the remediation continues towards completion of the remediation.

### FIELD

Embodiments disclosed herein relate generally to managing data processing systems. More particularly, embodiments disclosed herein relate to management of incident remediations for data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A-1B show diagrams illustrating a system in accordance with an embodiment.

FIGS. 2A-2B show interaction diagrams illustrating operation of a system in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems. The data processing systems may be managed by maintaining communication concerning remediations of incidents across data processing systems. The communication concerning the remediations of the incidents may be maintained by sending, by a deployment manager, notifications between a first data processing system with an incident, personnel assigned to remediation of the incident, and at least two other data processing systems that monitor progress of the remediation of the incident.

A management controller may observe an incident occurring in hardware components of the first data processing system. The management controller may report the incident to the deployment manager. The deployment manager may make an assignment of the personnel to remediate the incident and also notify the at least two other data processing systems of the assignment. Throughout steps of remediation of the incident, the at least two other data processing systems may be notified about progression of the remediation of the incident.

Once the personnel may remediate the incident, the personnel may notify the first data processing system that the issue has been remediated. Once the issue has been remediated, the management controller may notify the at least two other data processing systems that the issue has been remediated. Once the at least two other data processing systems have been notified, they may update status concerning the first data processing system.

In an embodiment, a method for managing data processing systems is disclosed. The method may include: (i) identifying, by a management controller of a first data processing system of the data processing system, an occurrence of an incident; (ii) identifying, by the management controller, at least two other data processing systems of the data processing system used by personnel assigned to manage issues impacting at least the first data processing system; (iii) reporting, by the management controller, the occurrence of the incident to the at least two other data processing systems to initiate an incident response for the incident; (iv) reporting, by the management controller, assignment of one of a personnel to attempt to manage the incident as part of the incident response to the at least two other data processing systems; (v) obtaining, by the management controller and from one of the other data processing systems used by the one of the personnel, a notification indicating that the incident has been remediated; and (vi) reporting, by the management controller and to the at least two other data processing systems, that the incident has been remediated so that all of the at least two other data processing systems are informed of the remediation of the incident and the incident response is ended.

Reporting the assignment may include obtaining, by the management controller, a notification indicating that the one of the personnel is assigned to manage the incident.

Reporting the assignment may further include (i) identifying, by the management controller, a portion of the at least two other data processing systems that are not assigned to manage the incident; and (ii) sending, by the management controller and to the portion of the at least two other data processing systems, notifications that the one personnel has been assigned to manage the incident to prevent some of the personnel using the portion of the at least two other data processing systems from taking action regarding the incident.

Each of at least two other data processing systems may host an instance of a console used to provide the personnel with information regarding operation of the data processing systems and receiving the information regarding the occurrence of the incident causes the console to update information presented to the personnel to inform them of the occurrence of the incident.

The management controller may monitor a physical state of hardware components of the first data processing system and provides feedback on the state of the hardware components.

The incident may be a condition which prohibits an activity or indicates current or potential for failure of operation of the first data processing system.

The incident having been remediated may indicate that a condition that gave rise to the incident is no longer present.

Reporting that the issue has been remediated may include (i) recognizing, by the management controller, that the incident has been remediated by the one of the personnel, and (ii) sending, by the management controller, a message to a portion of the at least two other data processing systems that are not assigned to manage the incident that the incident has been remediated.

The incident response is ended may indicate that a condition impacting the data processing system and giving rise to the incident is no longer present.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

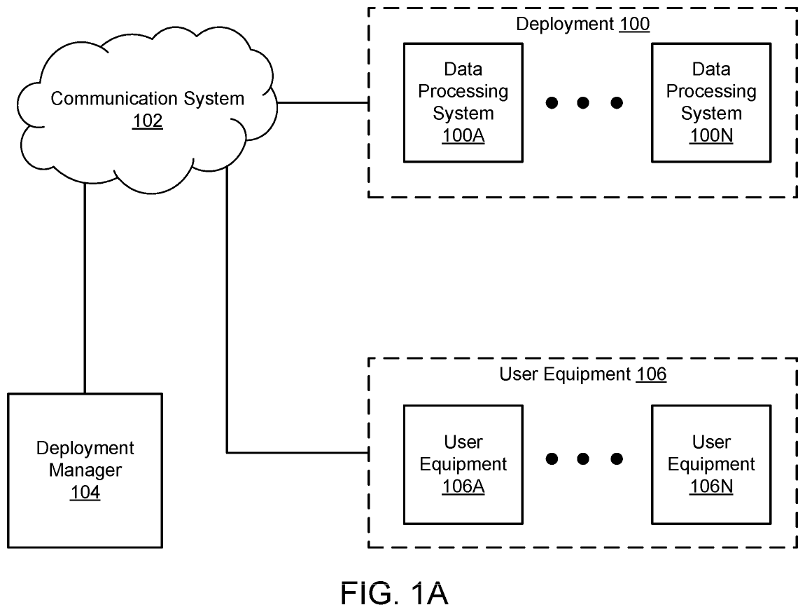

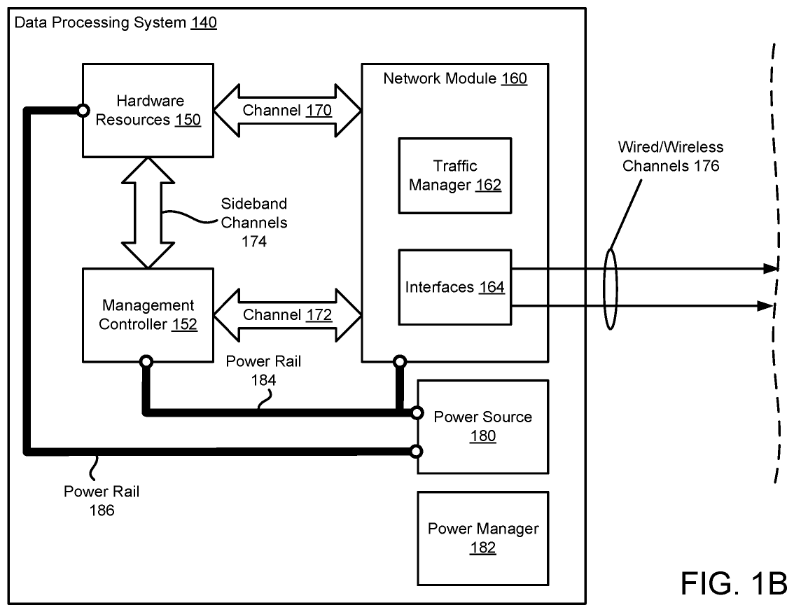

Turning to FIG. 1A, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, the system may include one or more data processing systems. The data processing systems may need to be in a predetermined operating state for the services to be provided. The predetermined operating state of the data processing systems may enable successful performance of, for example, data storage service, instant messaging services, etc.

If one or more of the data processing systems are not in a predetermined operating state, then one or more technicians (or other persons or automated systems, e.g., in aggregate “worker resources”) may be assigned to work on a data processing system. The one or more technicians may be assigned to work on the data processing system to remediate an operating state of the data processing system. In other words, to place it in the predetermined operating state.

For example, when an issue arises that causes a data processing system to leave the predetermined operating state, various undesired impacts on the operation of the data processing system may occur. These undesired impacts may be identified and used as a trigger condition to assign a worker resource to work on the data processing system.

However, when an issue arises that causes the data processing system to leave the predetermined operating state, multiple undesired impacts may occur that may not independently indicate a same root cause of the undesired impacts. Consequently, this may result in multiple trigger conditions being identified for a same root cause.

When multiple trigger conditions are identified, management systems that assign and manage use of worker resources may distribute information regarding these different undesired impacts to multiple worker resources and/or may assign multiple worker resources to work on different undesired impacts due to the same underlying cause. Thus, duplicative remediation effort may be made toward resolving the same issue.

Further, once one of the work resources resolves the underlying issue, the other worker resources that may work on the issue may not be aware that the issue has been resolved. Consequently, further unnecessary effort may be expended in attempting to resolve and already resolved issue.

To manage work performed on a data processing system, a record may be created to track progress of work performed on the data processing system to attempt to remediate of the operating state (e.g., return it to the predetermined operating state).

Additionally, when multiple technicians (or other entities) are assigned to work on the data processing system, the technicians may work together or independently. If the technicians work independently, then the technicians may attempt to implement different solutions to address the issue.

These different solutions may conflict with each other thereby preventing or impacting the ability of the issue to be resolved. For example, a first solution by a first technician may require changes in characteristics in the operating state that that was an underlying assumption for a second solution selected by a second technician. Thus, the independent activity of the technicians may reduce the likelihood of the issue being remediated. Accordingly, a data processing system may remain in an undesired state of operation for longer durations of time.

In general, embodiments disclosed here relate to systems and methods for managing data processing systems. The data processing systems may be managed by tracking when impacts of incidents that impact data processing systems have been resolved, and distributing information regarding the resolution of the incidents. An incident may be an event that changes the manner of operation of a data processing system in an undesirable manner.

When an incident occurs, one or more technicians may be assigned to attempt to resolve the incident. The technicians may not be aware that they are assigned to remediate the same issue.

To improve awareness of the incident and progress in the remediation of the issue, information regarding remediated issues may be distributed to the technicians assigned to work on the issue. The notifications may make the technicians that (a) an incident has occurred with the operating state of the data processing system; (b) one or more technicians have been assigned a task of remediation; and (c) once remediated, that the incident has been remediated.

Notifying all the technicians may ensure that all the technicians know when the data processing system that they have been assigned to work on is or and is not in a good operating state. Knowing when the data processing system is and is not in a good operating state may reduce duplicative effort, needless cost expenditures, and/or other undesired activity.

To provide the above noted functionality, the system may include deployment 100, deployment manager 104, and user equipment 106. Each of these components is discussed below.

Deployment 100 may include any number of data processing system 100A-s100N. Data processing systems 100A-100N may provide the computer implemented services. Data processing system 100A-100N may need to be in a predetermined operating state to provide computer implemented services. Should data processing system 100A-100N not be in a good operating state, deployment manager 104 may be notified and may initiate work to be performed on the data processing system.

Additionally, to reduce duplicative effort, any of data processing systems 100A-100N may host a management controller. The management controller may (i) monitor of operation of the host data processing system, (ii) communicate with deployment manager 104 to remediate the operation of the host data processing system when it is undesirable (e.g., out of the predetermine operating state) due to an occurrence of an issue, (iii) once the operating state has returned to the predetermined operating state, sent and/or initiate sending of notifications to reduce the likelihood of redundant and/or otherwise undesired remedial activity from being performed, and/or (iv) perform other types of actions. Refer to FIG. 1B for additional details regarding management controllers.

Deployment manager 104 may manage the operation of data processing systems 100A-100N by monitoring for changes in operating state of data processing systems 100A-100N and manage remediation of such changes through assignment and management of worker resources. Deployment manager 104 may assign technicians or other worker resources to work on data processing systems 100A-100N by sending notifications to user equipment 106. The notification may indicate occurrences of incidents for remediation, and/or progress of such remediations.

User equipment 106 may include any number of user equipment 106A-106N. User equipment 106A-106N to facilitate communication of information regarding the states of data processing systems 100A-100N between technicians and/or other worker resources, deployment manager 104, and/or data processing systems 100A-100N. For example, user equipment 106 may include cell phones, personal computing devices, and/or other computing devices usable by worker resources.

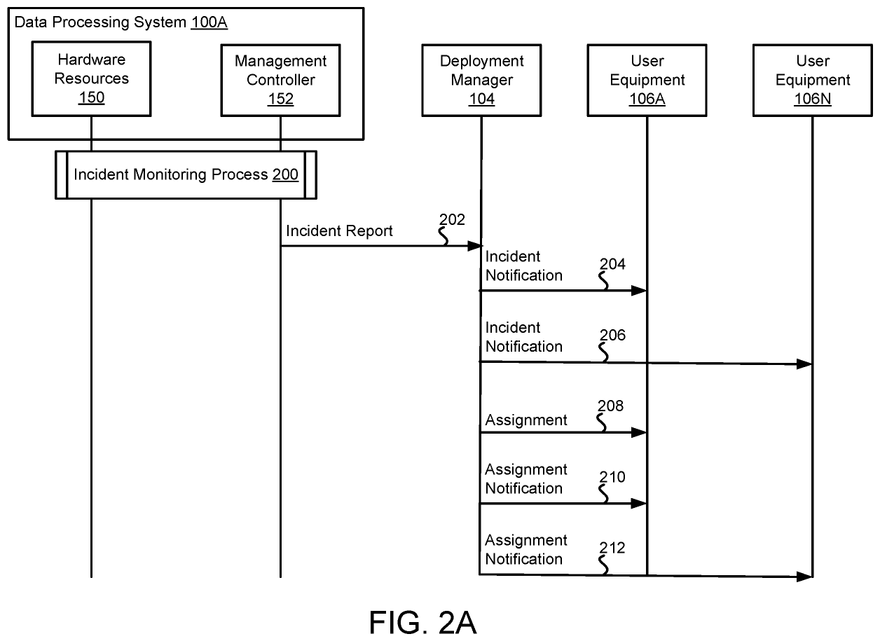

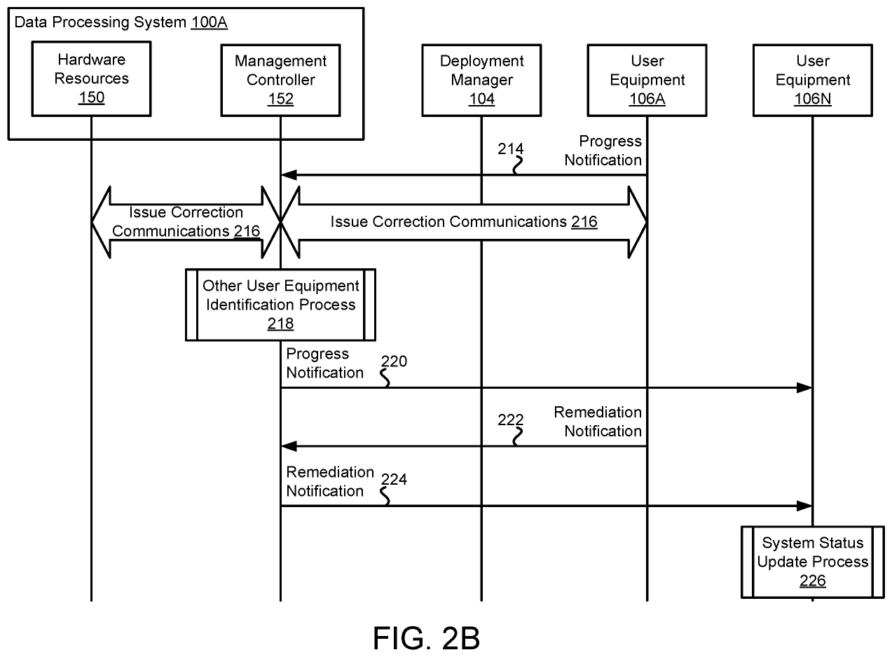

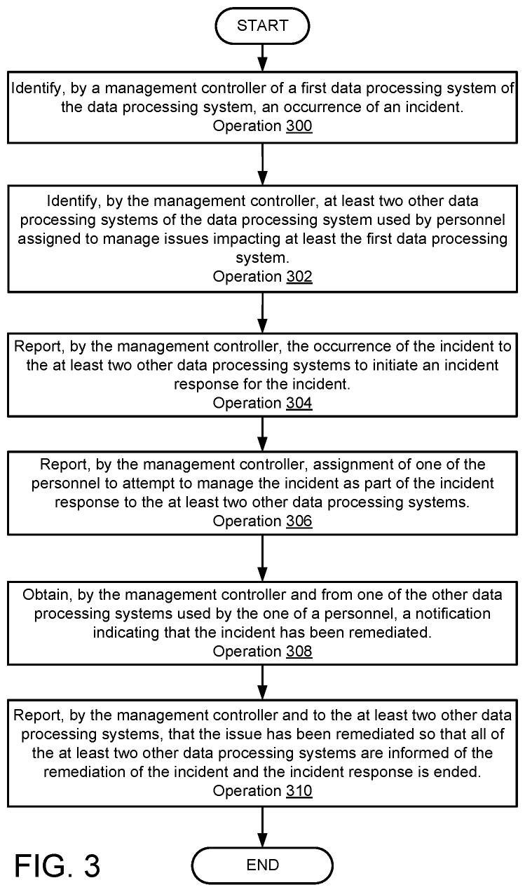

While providing their functionality, any of deployment 100, deployment manager 104, and user equipment 106 may perform all, or a portion, of the flows and methods shown in FIGS. 2A-3.

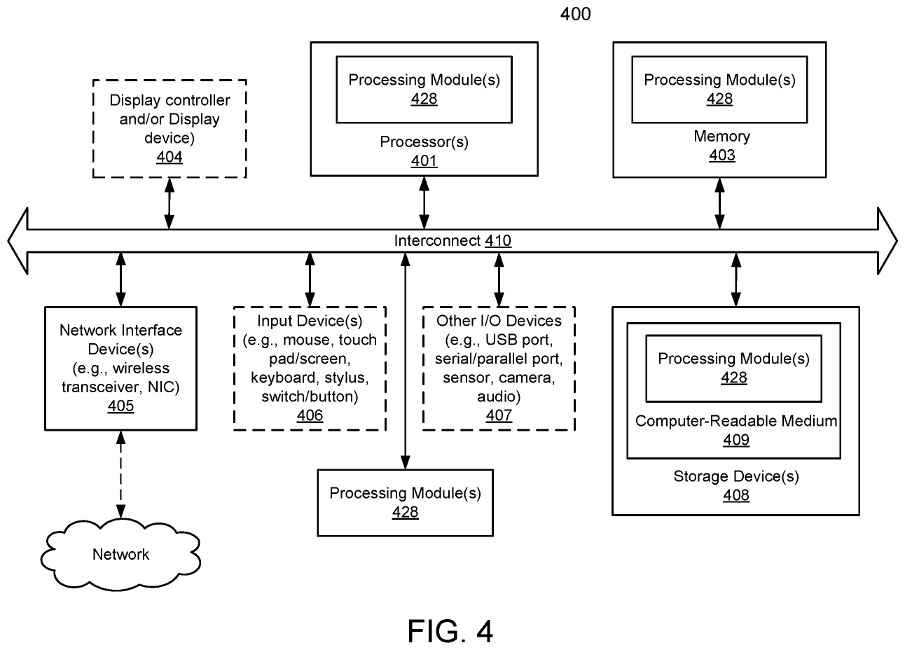

Any of (and/or components thereof) deployment 100, deployment manager 104, and user equipment 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1A may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1A as including a limited number of specific components, a system in accordance with an embodiment may include fewer, additional, and/or different components than those components illustrated therein.

Turning to FIG. 1B, a diagram illustrating data processing system 140 in accordance with an embodiment is shown. Data processing system 140 may be similar to any of the data processing systems 100A-100N shown in FIG. 1A.

To provide computer implemented services, data processing system 140 may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. For example, if various drivers and/or the communication stack are compromised, communications to/from other devices may be compromised. If the applications trust these communications, then the applications may also be compromised. Such compromises may be an occurrence of an incident.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 140) to another device via any number of intermediate networks (e.g., via wired/wireless channels 176 that are part of the networks).

To reduce the likelihood of the applications and/or other in-band entities from being indirectly compromised and/or to manage incident remediation, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150, of a host data processing system 140). Management controller 152 may provide various management functionalities for data processing system 140. For example, management controller 152 may monitor various ongoing processes performed by the in-band component, may manage power distribution, thermal management, and/or other functions of data processing system 140. Through this monitoring, management controller 152 may identify occurrences of incidents (e.g., undesired operation of in-band components).

To do so, management controller 152 may be operably connected to various components via sideband channels 174 (in FIG. 1B, a limited number of sideband channels are included for illustrative purposes, it will be appreciated that management controller 152 may communication with other components via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

Management controller 152 may be operably connected to communication components of data processing system 140 via separate channels (e.g., 172) from the in-band components, and may implement or otherwise utilize a distinct and independent network stack (e.g., TCP/IP). Consequently, management controller 152 may communication with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 140 may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 140, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These component may support any number of wired/wireless channels 176.

Thus, from the perspective of an external device, the in-band components and out-of-band components of data processing system 140 may appear to be two independent network entities, that may independently addressable, and otherwise unrelated to one another.

To manage the operation of data processing system 140, management controller 152 may send information regarding the state of data processing system 140 to other devices via channel 172 that allow other entities (e.g., user equipment, deployment managers, etc.) to identify occurrences of incidents impacting data processing system 140. Additionally, management controller 152 may track progress with respect to remediating the incidents. For example, management controller 152 may monitor the operating state of data processing system 140 and determine whether it has returned to a predetermined state. Once the operating state has returned to the predetermined operating state, then management controller 152 may send information to other entities (e.g., all entities provided with and/or assigned to manage corresponding incidents). Accordingly, all of the entities may become aware of and take appropriate action so as to not continue to expend resources attempting to resolve incidents that have already been resolved.

To facilitate management of data processing system 140 over time, hardware resources 150, management controller 152 and/or network module 160 may be positioned in separately controllable power domains. By being positioned in these separately power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 140 may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

To further clarify embodiments disclosed herein, interactions diagrams in accordance with an embodiment are shown in FIGS. 2A-2B. These interactions diagrams may illustrate how data may be obtained and used within the system of FIG. 1A-1B.

In the interaction diagrams, processes performed by and interactions between components of a system in accordance with an embodiment are shown. In the diagrams, components of the system are illustrated using a first set of shapes (e.g., 100A, 104, etc.), located towards the top of each figure. Lines descend from these shapes. Processes performed by the components of the system are illustrated using a second set of shapes (e.g., 200, 218, etc.) superimposed over these lines. Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 204. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may be performed to identify and manage incidents.

To identify when incidents have occurred, incident monitoring process may be performed. Incident monitoring process may be a cooperative process performed by hardware resources 150 and management controller 152. During incident monitoring process 200, management controller 100A may obtain information regarding the operation of hardware resources 150 to identify whether an incident has occurred. For example, management controller 152 may utilize sideband channels and/or other communication elements to query various hardware resources 150. The information obtained in this manner may allow management controller 152 to identify an operating state of hardware resources 150. The information may relate, for example, to processes being performed by, configuration of, and/or other types of information regarding hardware resources 150.

When an incident is identified, an incident report may be provided to deployment manager 140 at interaction 202. The incident report may include, for example, information regarding data processing system 100A, the collected information from hardware resources 150, and/or other information.

When an incident report is received by deployment manager 104, deployment manager 104 may initiate a process to manage the incident. The process may include sending information regarding the incident to various worker resources via user equipment (e.g., 106A-106N), assigning worker resources to work on data processing system 100A, and/or performing other actions to initiate remediation of the incident.

To initiate the remediation process, at interaction 202, an incident report may be sent to deployment manager 104. Upon receiving the incident report, deployment manager 104 may start the remediation process by, for example, notifying worker resources of the incident. The worker resources may be notified by sending, at interaction 208, an incident notification to user equipment 106A (e.g., used by a worker resource). The worker resources may address the incident by working on data processing system 100A (e.g., debugging, modifying operation of, etc.). Other worker resources may also be notified of the incident by sending other incident notifications (e.g., incident notification at interaction 206) to other user equipment (e.g., user equipment 106N).

After the worker resources are notified of the incident, a worker resource may be assigned to work on data processing system 100A to address the incident, and impacts thereof. The worker resource may be assigned by sending, at interaction 208, a notification of the assignment to equipment 106A in an example scenario in which the worker resource that uses user equipment 106A is assigned to manage the incident. The assignment may be made on any basis.

After the assignment is sent to user equipment 106A, deployment manager 104 may send notifications to user equipment 106A and user equipment 106N that indicate that the worker has been assigned to incident 202. For example, deployment manager 104 may send, at interactions 210 and 212, assignment notifications to corresponding user equipment.

Turning to FIG. 2B, a second interaction diagram in accordance with an embodiment is shown. The second interaction diagram may illustrate processes and interactions that may occur during progress towards remediation of the incident.

Continuing from the discussion of FIG. 2A, user equipment 106A may send, at interaction 214, a progress notification to management controller 100A. The progress notification may include or indicate acknowledgement of the assignment made at interaction 208 in FIG. 2A. Consequently, management controller 152 may be aware of the worker resource assigned to work on data processing system 100A to address the reported issue.

As the worker resource works on data processing system 100A, various communications may be made between hardware resources 150, management controller 152, and user equipment 106A. For example, to obtain information regarding and issue instructions to data processing system 100A, various issues correction communications 216 may be transmitted from user equipment 106A to management controller 152 and hardware resources 150.

For example, to work on data processing system 100A, the worker resource may identify and send instructions to hardware resources 150 to update its operation (e.g., install/remove software, modify hardware/software configurations, etc.). Likewise, to identify how to make such adjustments, various requests for information may be sent by user equipment 106A to hardware resources 150. Thus, various communications may be sent to facilitate remediation of the issue.

For example, commands may be sent by the worker resources through user equipment 106A to be implemented in data processing system 100A to remediate an incident. The commands may be received by management controller 100A and performed by hardware resources 100A.

Management controller 100A may provide information regarding whether the issue has been remediated and/or information regarding changes to the operation of data processing system 100A as the remediation is attempted, which may be sent to user equipment 106A. The worker resource may use the notifications from user equipment 106A to identify and issue more commands to attempt to remediate the issue.

While data processing system 100A is being worked on, other user equipment identification process 218 may be performed to keep the worker resources up to date regarding the progress of remediating the incident. During other user equipment identification process 218, other worker resources may be identified who are not involved in but may be aware of the issue. The other technicians may be notified of progress in the remediation of data processing system 100A. For example, at interaction 220, progress notifications may be sent to the user equipment (e.g., user equipment 106N in this example) used by the other worker resources.

Once the issue impacting data processing system 100A is remediated, the worker resource assigned to work on the issue may, at interaction 222, send a remediation notification. The remediation notification may indicate that the issue has been remediated. While illustrated in FIG. 2B as being sent by a worker resource, it will be appreciated that, for example, management controller 152 may identify that the remediation is complete. For example, management controller 152 may monitor the operation of hardware resources 150 and compare it to a known acceptable operating state. If matching the known acceptable operating state, then management controller 152 may conclude that the remediation is complete.

Once it is identified that the remediation is complete, management controller 100A may, at interaction 224, send remediation notifications to worker resources that are aware of but that are not assigned to work on the issue. For example, such notifications may be sent to user equipment 106N in this example so that the local dashboard or other interface used by the worker resource and presented by user equipment 106N may be updated.

Upon receiving the remediation notification, user equipment 106N may perform system status update process 226. During system status update process 226, user equipment 106N may generate records, update interfaces, and/or take other action on the basis that data processing system 100A has been remediated. As a result, all worker resources may be notified that data processing system 100A has been remediated.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1A may perform various methods to manage data processing systems. FIG. 3 illustrates a method that may be performed by the components of the system of FIG. 1A. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing data processing systems in accordance with an embodiment is shown. The method may be performed, for example, by any of the components of the system of FIG. 1A, and/or other components not shown therein.

At operation 300, an occurrence of an incident may be identified by a management controller of a first data processing system of a data processing system. The occurrence may be identified by monitoring, by the management controller, hardware components of the data processing system.

At operation 302, at least two other data processing systems of the data processing system, used by personnel (e.g., worker resources) assigned to manage issues impacting at least the first data processing system, may be identified. The at least two other data processing systems may be identified by selecting, by a deployment manager and from a roster of data processing systems, the at least two other data processing systems of the data processing system.

At operation 304, the occurrence of the incident may be reported, by the management controller, to the at least two other data processing systems to initiate an incident response for the incident. The occurrence of the incident may be reported, by the management controller, by notifying the deployment manager of the occurrence of the incident. Upon notification of the occurrence of the incident, the deployment manager may notify the at least two other data processing systems, from selection of the roster of data processing systems, about occurrence of the incident.

At operation 306, assignment of one of the personnel to attempt to manage the incident as part of the incident response to the at least two other data processing systems may be reported by the management controller. The assignment of one of the personnel may be reported by obtaining, by the management controller, a notification indicating that the one of the personnel is assigned to manage the incident. The notification may be obtained by receiving a message, by the management controller, from the deployment manager about assignment of one of the personnel.

The assignment of one of the personnel may be further reported by (i) identifying, by the management controller, a portion of the at least two other data processing systems that are not assigned to manage the incident; and (ii) sending, by the management controller and to the portion of the at least two other data processing systems, notifications that the one personnel has been assigned to manage the incident to prevent some of the personnel using the portion of the at least two other data processing systems from taking action regarding the incident.

A portion of the at least two other data processing systems that are not assigned to manage the incident may be identified by observing, by the deployment manager and from a roster of data processing systems, the at least two other data processing systems that are not assigned to manage the incident. The notifications that the one personnel has been assigned to manage the incident may be sent by passing, by the deployment manager, a message to the management controller the notifications that the one personnel has been assigned to manage the incident.

At operation 308, a notification indicating that the incident has been remediated may be obtained by the management controller and from one of the other data processing systems used by the one of the personnel. The notification may be obtained by receiving a message from the one personnel through the deployment manager.

At operation 310, remediation of the issue may be reported, by the management controller and to the at least two other data processing systems, so that all of the at least two other data processing systems are informed of the remediation of the incident and the incident response is ended. The remediation of the issue may be reported by (i) confirming, by the management controller, that the incident has been remediated by the one of the personnel, and (ii) sending, by the management controller, a message to a portion of the at least two other data processing systems that are not assigned to manage the incident that the incident has been remediated.

Remediation of the issue may be recognized by receiving, by the management controller, a message from the personnel stating that the issue has been remediated. A message that the incident has been remediated may be sent by passing the message that the incident has been remediated from the management controller to the at least two other data processing systems.

The method may end following operation 310.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing data processing systems, the method comprising:
identifying, by a management controller of a first data processing system of the data processing system, an occurrence of an incident;
identifying, by the management controller, at least two other data processing systems of the data processing system used by personnel assigned to manage issues impacting at least the first data processing system;
reporting, by the management controller, the occurrence of the incident to the at least two other data processing systems to initiate an incident response for the incident;
reporting, by the management controller, assignment of one of a personnel to attempt to manage the incident as part of the incident response to the at least two other data processing systems;
obtaining, by the management controller and from one of the other data processing systems used by the one of the personnel, a notification indicating that the incident has been remediated; and
reporting, by the management controller and to the at least two other data processing systems, that the incident has been remediated so that all of the at least two other data processing systems are informed of the remediation of the incident and the incident response is ended.

2. The method of claim 1, wherein reporting the assignment comprises obtaining, by the management controller, a notification indicating that the one of the personnel is assigned to manage the incident.

3. The method of claim 2, wherein reporting the assignment further comprises:
identifying, by the management controller, a portion of the at least two other data processing systems that are not assigned to manage the incident; and
sending, by the management controller and to the portion of the at least two other data processing systems, notifications that the one personnel has been assigned to manage the incident to prevent some of the personnel using the portion of the at least two other data processing systems from taking action regarding the incident.

4. The method of claim 1, wherein each of at least two other data processing systems hosts an instance of a console used to provide the personnel with information regarding operation of the data processing systems and receiving the information regarding the occurrence of the incident causes the console to update information presented to the personnel to inform them of the occurrence of the incident.

5. The method of claim 1, wherein the management controller monitors a physical state of hardware components of the first data processing system and provides feedback on the state of the hardware components.

6. The method of claim 1, wherein the incident is a condition which prohibits an activity or indicates current or potential for failure of operation of the first data processing system.

7. The method of claim 1, wherein the incident having been remediated indicates that a condition that gave rise to the incident is no longer present.

8. The method of claim 1, wherein reporting that the issue has been remediated comprises:
recognizing, by the management controller, that the incident has been remediated by the one of the personnel, and
sending, by the management controller, a message to a portion of the at least two other data processing systems that are not assigned to manage the incident that the incident has been remediated.

9. The method of claim 1, wherein the incident response is ended indicates that a condition impacting the data processing system and giving rise to the incident is no longer present.

10. A non-transitory machine-readable medium having instructions stored therein, which when executed by a processor, cause the processor to perform operations for managing data processing systems, the operation comprising:
identifying, by a management controller of a first data processing system of the data processing system, an occurrence of an incident;
identifying, by the management controller, at least two other data processing systems of the data processing system used by personnel assigned to manage issues impacting at least the first data processing system;
reporting, by the management controller, the occurrence of the incident to the at least two other data processing systems to initiate an incident response for the incident;
reporting, by the management controller, assignment of one of a personnel to attempt to manage the incident as part of the incident response to the at least two other data processing systems;
obtaining, by the management controller and from one of the other data processing systems used by the one of the personnel, a notification indicating that the incident has been remediated; and
reporting, by the management controller and to the at least two other data processing systems, that the incident has been remediated so that all of the at least two other data processing systems are informed of the remediation of the incident and the incident response is ended.

11. The non-transitory machine-readable medium of claim 10, wherein reporting the assignment comprises
obtaining, by the management controller, a notification indicating that the one of the personnel is assigned to manage the incident.

12. The non-transitory machine-readable medium of claim 11, wherein reporting the assignment further comprises:
identifying, by the management controller, a portion of the at least two other data processing systems that are not assigned to manage the incident; and
sending, by the management controller and to the portion of the at least two other data processing systems, notifications that the one personnel has been assigned to manage the incident to prevent some of the personnel using the portion of the at least two other data processing systems from taking action regarding the incident.

13. The non-transitory machine-readable medium of claim 10, wherein each of at least two other data processing systems hosts an instance of a console used to provide the personnel with information regarding operation of the data processing systems and receiving the information regarding the occurrence of the incident causes the console to update information presented to the personnel to inform them of the occurrence of the incident.

14. The non-transitory machine-readable medium of claim 10, wherein the management controller monitors a physical state of hardware components of the first data processing system and provides feedback on the state of the hardware components.

15. The non-transitory machine-readable medium of claim 10, wherein the incident is a condition which prohibits an activity or indicates current or potential for failure of operation of the first data processing system.

16. A data processing system, comprising:
a processor; and
a memory coupled to the processor to store instructions, which when executed by the processor, cause the processor to perform operations for managing data processing systems, the operations comprising:
identifying, by a management controller of a first data processing system of the data processing system, an occurrence of an incident;
identifying, by the management controller, at least two other data processing systems of the data processing system used by personnel assigned to manage issues impacting at least the first data processing system;
reporting, by the management controller, the occurrence of the incident to the at least two other data processing systems to initiate an incident response for the incident;
reporting, by the management controller, assignment of one of a personnel to attempt to manage the incident as part of the incident response to the at least two other data processing systems;
obtaining, by the management controller and from one of the other data processing systems used by the one of the personnel, a notification indicating that the incident has been remediated; and
reporting, by the management controller and to the at least two other data processing systems, that the incident has been remediated so that all of the at least two other data processing systems are informed of the remediation of the incident and the incident response is ended.

17. The data processing system of claim 16, wherein reporting the assignment comprises
obtaining, by the management controller, a notification indicating that the one of the personnel is assigned to manage the incident.

18. The data processing system of claim 17, wherein reporting the assignment further comprises:
identifying, by the management controller, a portion of the at least two other data processing systems that are not assigned to manage the incident; and
sending, by the management controller and to the portion of the at least two other data processing systems, notifications that the one personnel has been assigned to manage the incident to prevent some of the personnel using the portion of the at least two other data processing systems from taking action regarding the incident.

19. The data processing system of claim 16, wherein each of at least two other data processing systems hosts an instance of a console used to provide the personnel with information regarding operation of the data processing systems and receiving the information regarding the occurrence of the incident causes the console to update information presented to the personnel to inform them of the occurrence of the incident.

20. The data processing system of claim 16, wherein the management controller monitors a physical state of hardware components of the first data processing system and provides feedback on the state of the hardware components.
